(19) United States
(12) Patent Application Publication
(10) Pub. No.: US 2005/0246339 A1
(43) Pub. Date: Nov. 3, 2005

(54) Method and device for data retrieval, and computer product

(75) Inventors: Masakatsu Kamegaya, Kawasaki (JP); Kazuhisa Shibafuji, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/928,153

(22) Filed: Aug. 30, 2004

(30) Foreign Application Priority Data
Apr. 28, 2004 (JP) 2004-133804

(51) Int. Cl. G06F 7/00

(52) U.S. Cl. 707/9

(57) ABSTRACT

A data retrieval system is provided in which it is obligatory for a user to sign up as a member by registering with the system to register a message on a server. When registering the message, the member specifies at least one e-mail address of a person (permitted user) who is permitted to view the message registered by him/her. A seeker need not register to retrieve a message from the server. However, the seeker should have been specified as a permitted user by at least one member. In other words, as the server returns as a search result only the messages of the member who has specified the e-mail address of the seeker as the permitted user, the seeker who has not been specified as a permitted user by any of the members will be unable to view any message.

### CROSS-REFERENCE TO RELATED APPLICATIONS

This application is based upon and claims the benefit of priority from the prior Japanese Patent Application No. 2004-133804, filed on Apr. 28, 2004, the entire contents of which are incorporated herein by reference.

### BACKGROUND OF THE INVENTION

1) Field of the Invention

The present invention relates to a technology for retrieval of data registered in a database.

2) Description of the Related Art

Services that allow a user to notify the user's safety or check the safety of family and acquaintances via bulletin boards set up at times of extensive disasters such as an earthquake, etc. are well known. For instance, according to the conventional art disclosed in Non-Patent Literature 1, User B can view a message posted on the bulletin board by User A by entering User A's mobile number. Unlike the regular bulletin boards, one's privacy is taken into consideration in that this bulletin board allows only those persons to view the messages who know one's mobile number.

Non-Patent Literature 1: Jan. 9, 2004 “Launching i-Mode Disaster Bulletin Board Service” [online] by NTT DoCoMo Incorporated [Reference Apr. 28, 2004], Internet site URL: http://www.nttdocomo.co.jp/new/contents/04/whatnew0109.html

However, if a company wants to check the safety of it's employees, the telephone numbers of all the employees have to be entered one by one. However, this approach is time consuming. Since, telephone numbers do not readily come to mind, the need for using names instead of telephone numbers of the employees was felt. However, this too has a disadvantage in that there is no unique way to identify users by full name (due to users sharing the same family names and personal names). Further, if an unauthorized person enters the correct telephone number of another person by fluke, he/she can view the message.

### SUMMARY OF THE INVENTION

It is an object of the present invention to solve at least the problems in the conventional technology.

A data retrieval method according to an aspect of the present invention is a method that retrieves messages registered in a database. The method includes receiving a retrieval request from a first user; identifying the first user based on the retrieval request; retrieving a second user from the database who has specified the first user as a permitted user; retrieving a message from the database that is registered by the second user; and transmitting the message to the first user.

A data retrieval device according to another aspect of the present invention is a device that retrieves messages registered in a database. The device includes a receiving unit that receives a retrieval request from a first user; an identifying unit that identifies the first user based on the retrieval request; a user retrieving unit that retrieves a second user from the database who has specified the first user as a permitted user; a message retrieving unit that retrieves a message from the database that is registered by the second user; and a transmitting unit that transmits the message to the first user.

The computer program according to still another aspect of the present invention causes a computer to execute the above method according to the present invention.

The computer-readable recording medium according to still another aspect of the present invention stores therein the above computer program according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an overall structure of a data retrieval system that includes a data retrieval device according to an embodiment of the present invention;

FIG. 2 is a hardware configuration of the data retrieval device shown in FIG. 1;

FIG. 3 is a functional configuration of the data retrieval device shown in FIG. 1;

FIG. 4 is an example of contents of a user database (DB) shown in FIG. 3;

FIG. 5 is a flowchart of a process of user registration to the user DB shown in FIG. 4;

FIG. 6 is a sample user registration form displayed on a terminal of a member shown in FIG. 1;

FIG. 7 is a sample user registration completion notice on the terminal of the member shown in FIG. 1;

FIG. 8 is a flowchart of a process of message registration to a message DB shown in FIG. 3;

FIG. 9 is a sample message registration completion notice on the terminal of the member shown in FIG. 1;

FIG. 10 is a flowchart of a process of message retrieval from the message DB shown in FIG. 3;

FIG. 11 is another example of contents of the user shown in FIG. 1; and

FIG. 12 is a sample search result on a terminal of a seeker shown in FIG. 1.

### DETAILED DESCRIPTION

Exemplary embodiments of a method and a device for data retrieval, and a computer product according to the present invention are explained next with reference to the accompanying drawings.

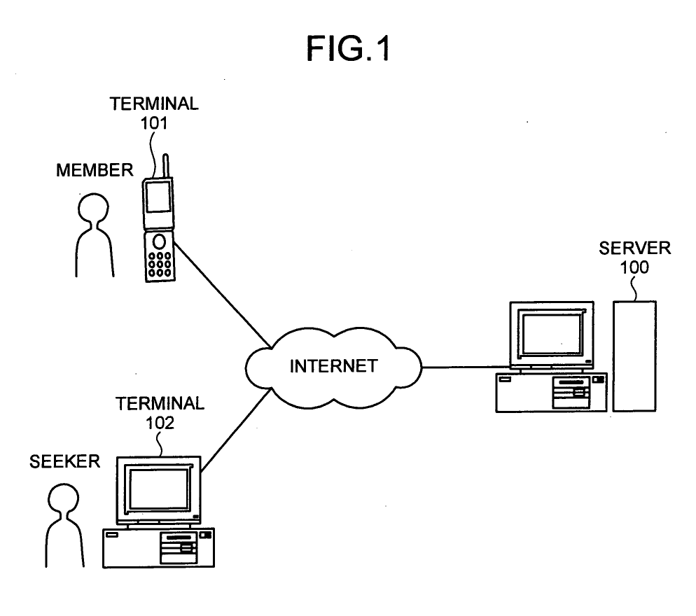

FIG. 1 is an overall structure of a data retrieval system that includes a data retrieval device according to an embodiment of the present invention. The data retrieval device is a server 100. The server 100 registers a message or retrieves the registered message in response to a request from a user. Unless specified otherwise, the term ‘registration’ not only refers to registration of new data but also re-registration of an earlier registered data after modification of its contents.

The reference numeral 101 represents a terminal of a user (hereinafter, “member”) who registers the message on the server 100 and the reference numeral 102 represents a terminal of a user (hereinafter, “seeker”) who retrieves the message from the server 100. Both the terminals are connected via the server 100 and the Internet. Though the terminal 101 of the member is assumed to be a mobile phone and the terminal 102 of the seeker is assumed to be a personal computer (PC), they may be any device, such as a personal digital assistant (PDA), equipped with a function of sending and receiving e-mail.

It is obligatory for a user to sign up as a member by registering with the data retrieval system to register a message on the server 100. When registering the message, the member specifies at least one person (hereinafter, “permitted user”) who can view the messages registered by him/her. The seeker however need not register as a member to retrieve a message from the server. However, the seeker should have been specified as the permitted user of at least one of the members. In other words, since the server 100 returns as a search result only the messages of the member who specifies a permitted user, a seeker who has not been specified as a permitted user by any of the members will be unable to view any message.

All the processing requests from the terminals 101 and 102 to the server 100 and all the responses of the processing results from the server 100 to the terminal 101 and 102 are mainly carried out via e-mail. Since a requesting party can be identified from the sender's address field in the e-mail header, the e-mail address is used as a unique identification data of the user. The type of the request is identified from the text string in the title field (subject line) of the e-mail.

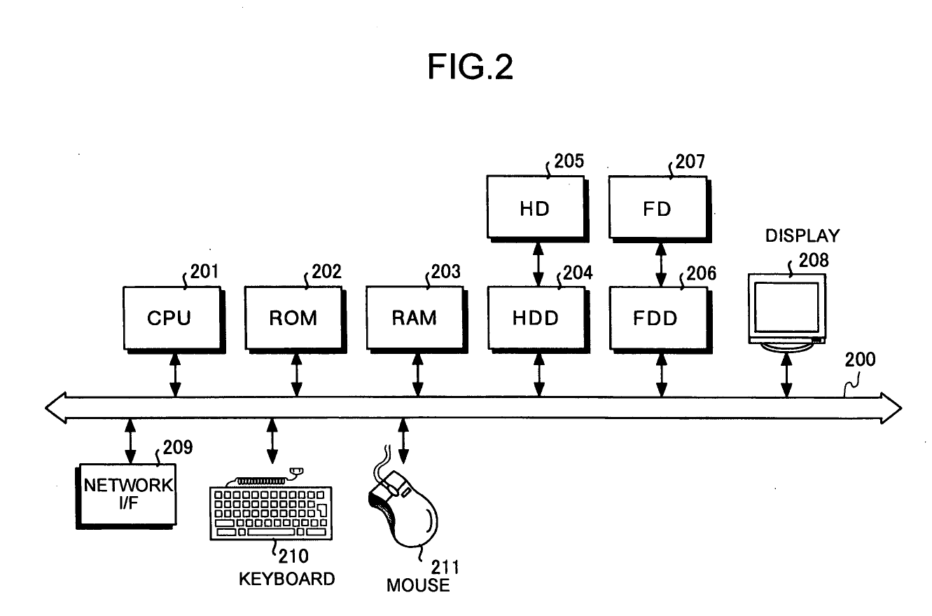

FIG. 2 is a hardware configuration of the data retrieval device (to be more specific, the server 100 shown in FIG. 1). A central processing unit (CPU) 201 controls the entire data retrieval device. A read-only memory (ROM) 202 stores a boot program. A random access memory (RAM) 203 is used as a work area of the CPU 201.

A hard disk drive (HDD) 204 controls reading data from/writing data to a hard disk (HD) 205 according to the control of the CPU 201. The HD 205 stores the write data according to the control of the HDD 204. A floppy disk drive (FDD) 206 controls reading data from/writing data to a floppy disk (FD) 207 according to the control of the CPU 201. The FD 207 stores the write data according to the control of the FDD 206. The FD 207 is just an example of a removable recording medium. Alternatively, a compact-disk read-only memory (CD-ROM) (such as a compact disk-recordable (CD-R) and a compact disk-rewritable (CD-RW)), a magneto optical disk (MO), a digital versatile disk (DVD), a memory card, and the like, may be used instead of the FD 207.

A display 208 displays cursors, windows, and icons as well as various data such as documents, images, etc. A network interface (network I/F) 209 is connected to the Internet and manages exchange of data between the network and the device. A keyboard 210 is provided with a plurality of keys for entering characters, numerals, and various instructions. When a user presses the keys of the keyboard 210, data corresponding to those keys is input into the device. A mouse 211 inputs into the device the data corresponding to the rotation amount and rotation direction of a ball on the underside of the mouse and the data corresponding to the ON/OFF of each button situated on the surface the mouse. A bus 200 connects all the parts mentioned above.

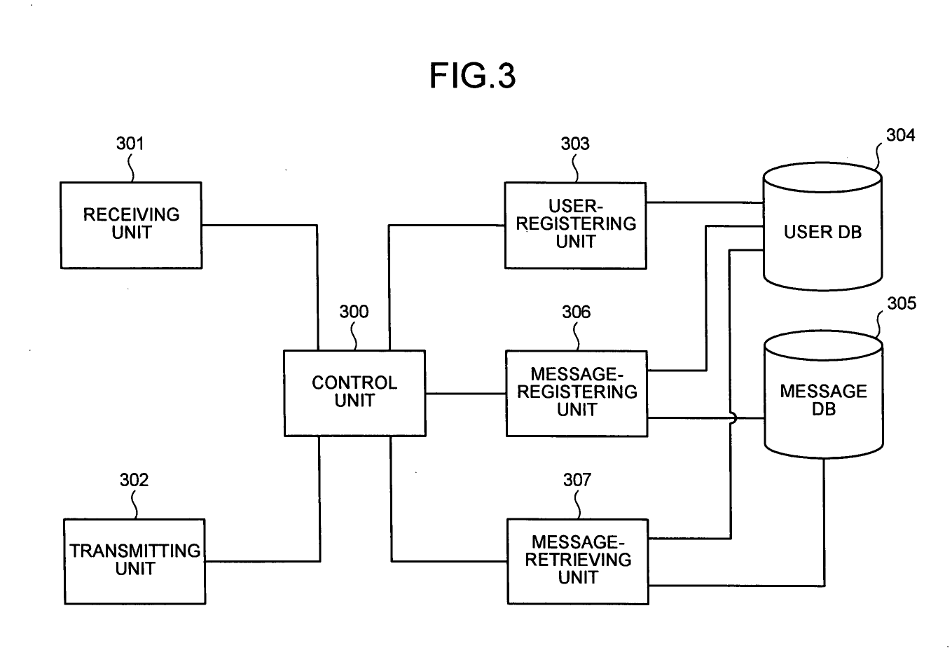

FIG. 3 is a functional configuration of the data retrieval device (to be more specific, the server 100 shown in FIG. 1). The server 100 includes a control unit 300, a receiving unit 301, a transmitting unit 302, a user-registering unit 303, a user database (DB) 304, a message database (DB) 305, a message-registering unit 306, and a message-retrieving unit 307.

The control unit 300 controls all the units from the receiving unit 301 to the message-retrieving unit 307 and is a functional unit that realizes a user registration process and a message registration/retrieval process. The receiving unit 301 is a functional unit that receives all the processing requests from the terminal 101 of the member and the terminal 102 of the seeker to the server 100 in an e-mail form. The transmitting unit 302 is a functional unit that sends the result of the requested process to the terminals 101 and 102 in an e-mail form.

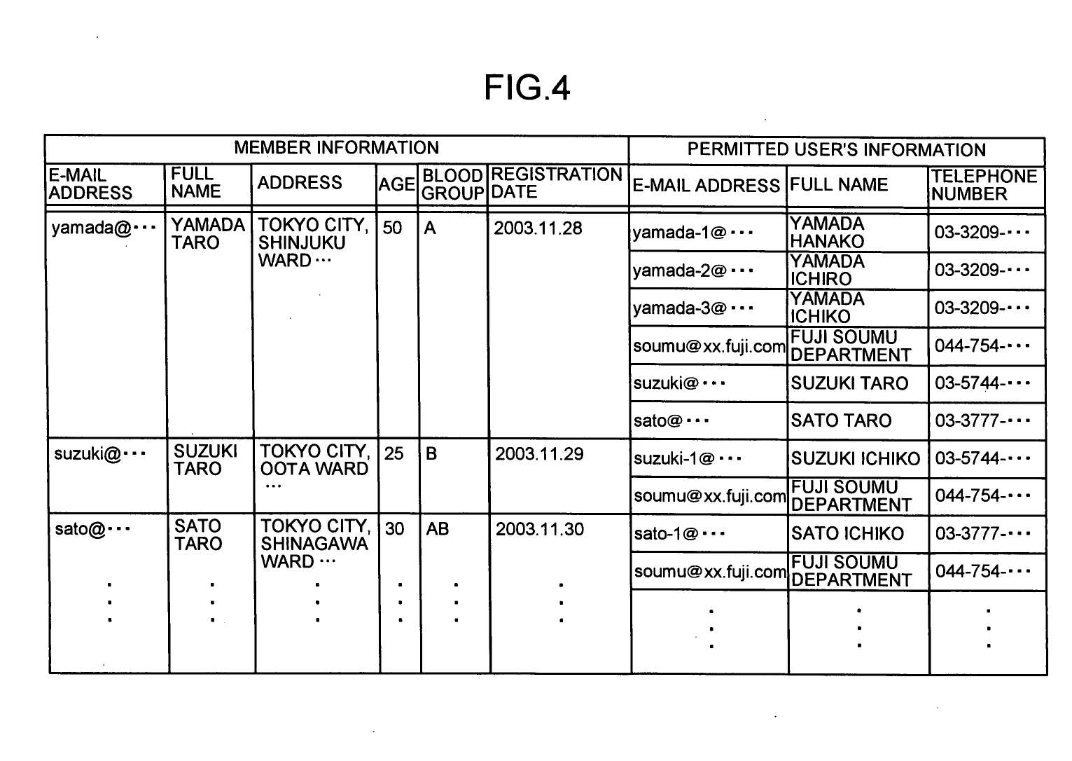

The user-registering unit 303 is a functional unit that controls the registration of the user to the user DB 304. FIG. 4 is an example of contents of the user DB 304. The user DB 304, broadly speaking, maintains information pertaining to the member and the permitted user. The information pertaining to the member should include at least the e-mail address and the full name of the member. The information pertaining to the permitted user should include at least the e-mail address. It is preferable to have an ID photograph of the member as part of the information pertaining to the member.

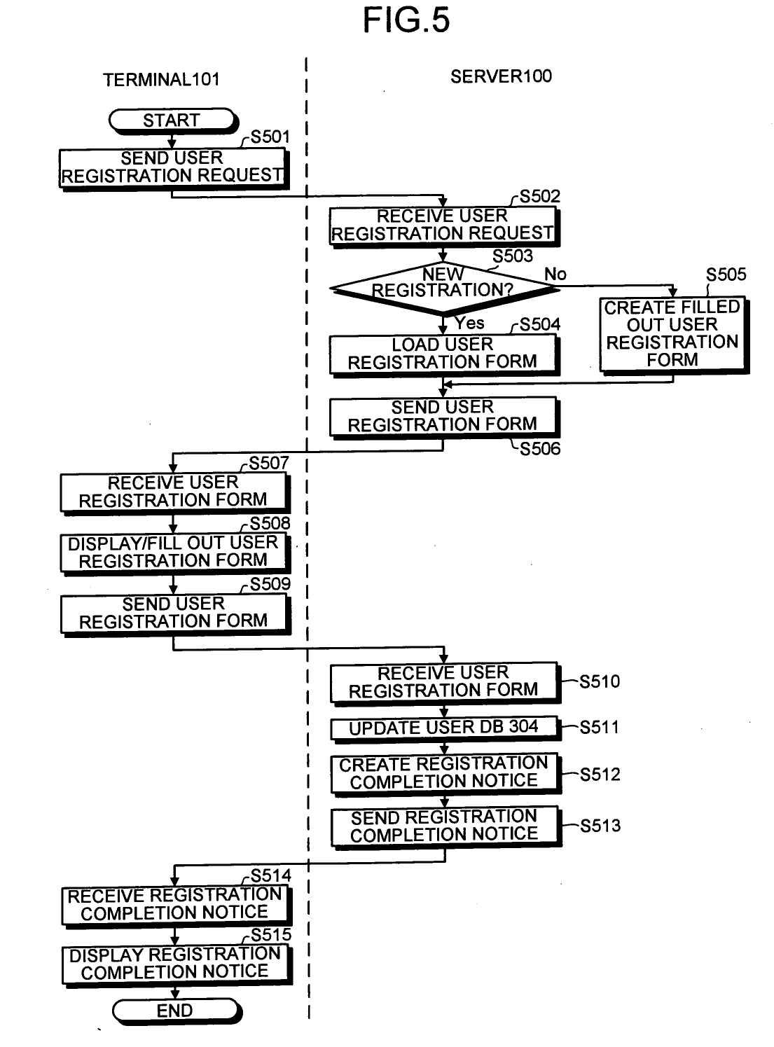

FIG. 5 is a flowchart of a process of user registration to the user DB 304. The user who wishes to be registered sends from the terminal 101 an e-mail of a predetermined format that indicates a user registration request to the server 100 (Step S501). This e-mail includes the e-mail address (for instance, sgibbs@fuji.com) of the server 100 in the receiver's address field, the e-mail address of the terminal 101 in the sender's address field, and a predetermined text string (for instance, “user registration”) indicating a request for user registration in the title field. The main body of the e-mail may be blank.

The control unit 300 of the server 100 receives the e-mail via the receiving unit 301 (Step S502) and identifies it as the user registration request. The control unit 300 then instructs the user-registering unit 303 to determine whether the received request is for a new registration or a re-registration (modification of the pre-registered contents) (Step S503). The user-registering unit 303, upon receiving the instruction from the control unit 300, searches the user DB 304. If the requesting party (more accurately, the sender's address in the e-mail) is not yet registered, the user-registering unit 303 assesses the request as a new registration request and if the requesting party is already registered, the user-registering unit 303 assesses the request as a re-registration request.

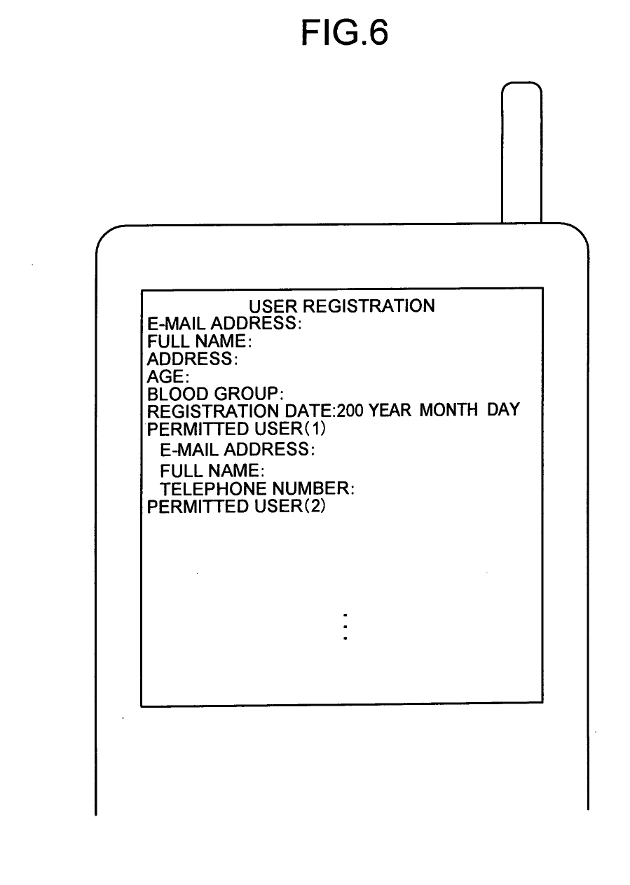

If the request is a new registration request (‘Yes’ in Step S503), the user-registering unit 303 loads a user registration form (Step S504) and passes it on to the control unit 300. The control unit 300, upon receiving the user registration form, sends it to the terminal 101 via the transmitting unit 302 (Steps S506 and S507). The terminal 101 displays on the screen the user registration form as shown in FIG. 6 (Step S508).

All the fields that appear in FIG. 6 correspond to the fields of the user DB 304 shown in FIG. 4. In FIG. 6, there is only provision for registering one e-mail address of the member. However, provision may be made for registering several e-mail addresses, such as e-mail address of the mobile phone, member's home PC, company's PC, etc. Moreover, the user need not be made to enter the registration date and the entry of the date may be set automatically to the user DB 304 at the time of registration.

Returning to FIG. 5, the member enters the necessary information in the required fields and sends the user registration form from the terminal 101 to the server 100 (Step S508 and Step 509). If the request is for re-registration (‘No’ in Step S503), the user-registering unit 303 sends to the terminal 101 the registration form with the current values in the fields. The member may modify the entries as required and send the registration form back to the server 100 (Steps S505 through S507).

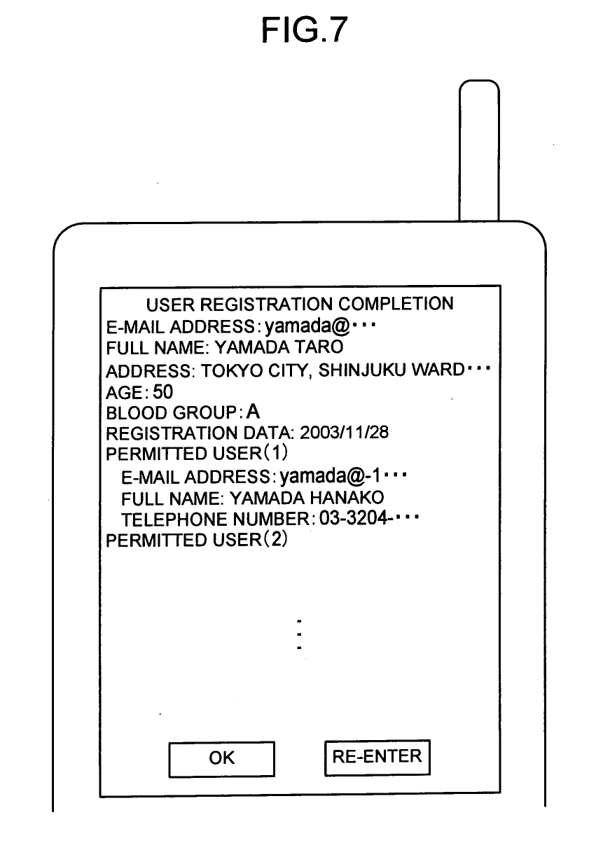

The user-registering unit 303 receives the filled out user registration form via the receiving unit 301 and the control unit 300 (Step S510) and updates the user DB 304 (Step S511). The user-registering unit 303 then creates a user registration completion notice (Step S512), and passes it on to the control unit 300. The control unit 300 sends the user registration completion notice to the terminal 101 via the transmitting unit 302 (Steps S513 and S514). The terminal 101 displays on the screen the user registration completion notice as shown in FIG. 7 (Step S515).

Returning to FIG. 3, the message DB 305 is a database that contains all the messages registered on the server 100, the message-registering unit 306 is a functional unit that registers the messages in the message DB 305 in response to the request from the member, and the message-retrieving unit 307 is a functional unit that retrieves the messages from the message DB 305 in response to the request from the seeker.

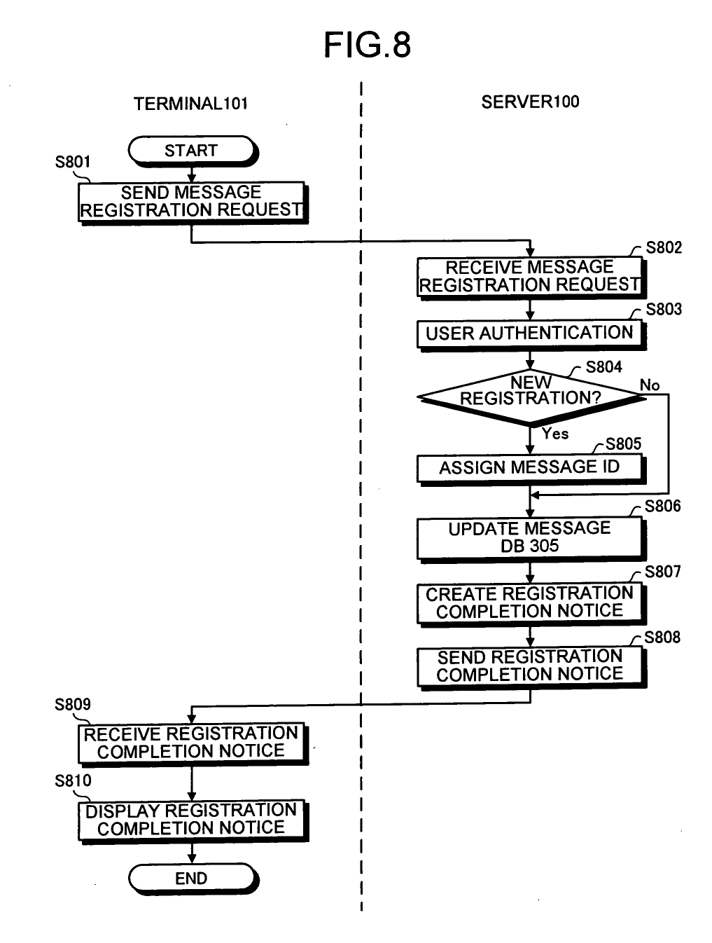

FIG. 8 is a flowchart of a process of message registration to the message DB 305. The user who wishes to register the message sends from the terminal 101 an e-mail of a predetermined format that indicates a message registration request to the server 100 (Step S801). This e-mail includes, the e-mail address (for instance, sgibbs@fuji.com) of the server 100 in the receiver's address field, the e-mail address of the terminal 101 in the sender's address field, the title (for new registration) or the message ID (for re-registration) of the message in the title field, and the text of the message in the main body of the e-mail.

The control unit 300 of the server 100 receives the e-mail via the receiving unit 301 (Step S802) and identifies it as a message registration request. The control unit 300 then instructs the message-registering unit 306 to check whether the requesting party (more accurately, the sender's address in the e-mail) of the message registration request exists in the user DB 304 (Step S803). Message registration from the user who is not registered is denied at this user authentication step.

If the title of the received e-mail contains any text string other than the message ID, the message-registering unit 306 assesses the registration request to be for a new message (‘Yes’ in Step S804) and assigns a unique message ID to the message (Step S805). The message-registering unit 306 stores (updates) in the message DB 305 the message ID, the title of the message (the title of the e-mail), the text of the message (the same text), the e-mail address of the member (the same sender's address), and the date and time of registration (current date and time) of the message in a correlated form (Step S806).

If the title of the received e-mail contains a message ID, the message-registering unit 306 assesses the registration request is to be for re-registration of the message (modification of the pre-registered message contents) (Step S804: No). The message-registering unit 306 retrieves the message DB 305 with the message ID and updates the title of the message correlated to the message ID with the title in the e-mail, the main body of the message with the text in the e-mail, and the date and time of registration with the current date and time (Step S806).

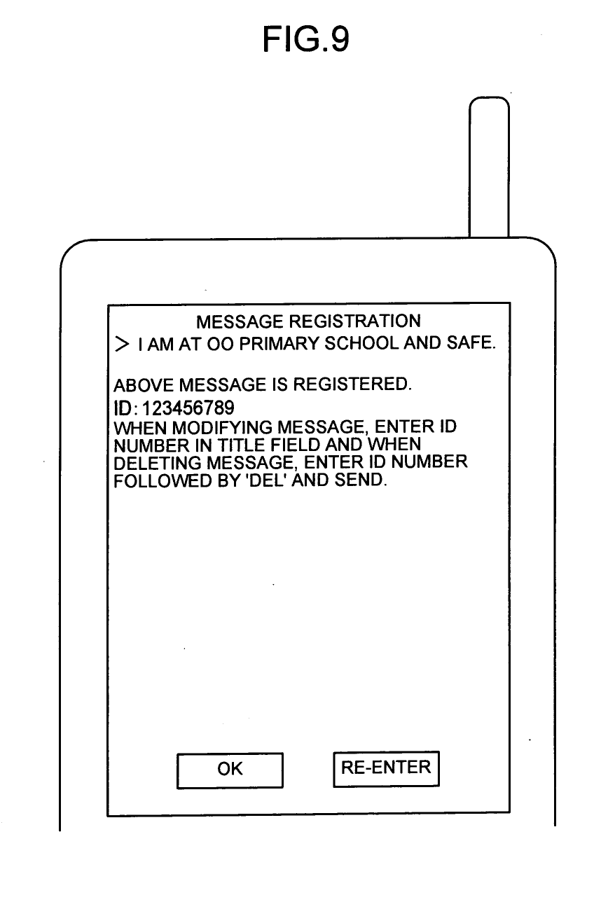

Next, the message-registering unit 306 creates a message registration completion notice (Step S807) and sends it to the terminal 101 via the control unit 300 and the transmitting unit 302 (Steps S808 and S809). The terminal 101 displays on the screen the message registration completion notice as shown in FIG. 9 (Step S810).

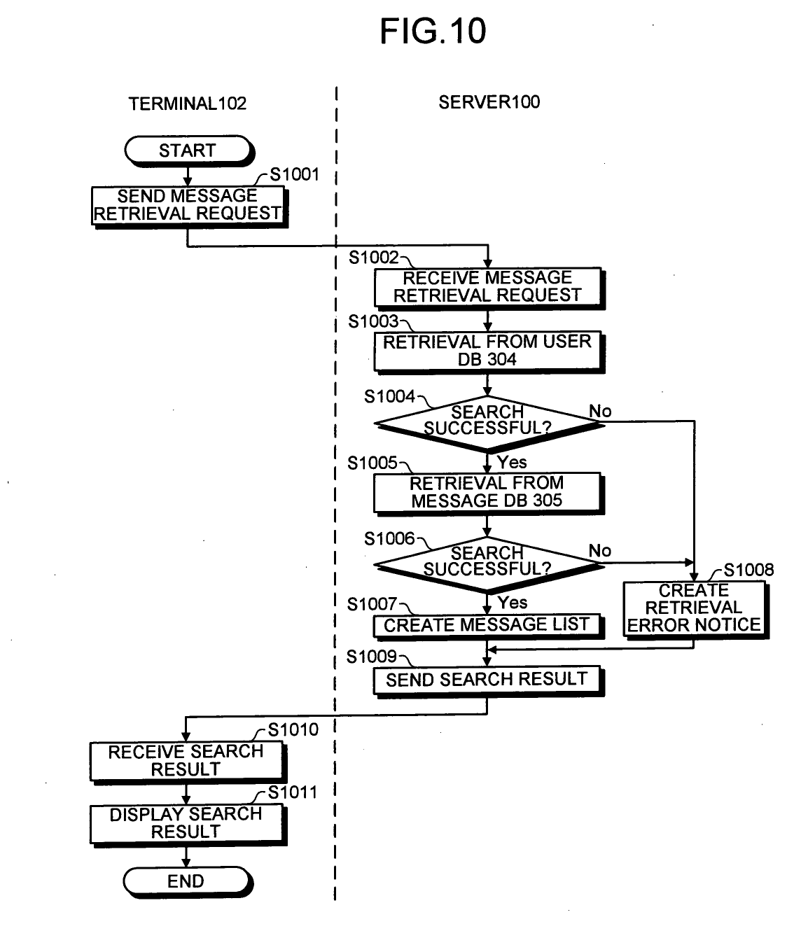

FIG. 10 is a flowchart of a process of message retrieval from the message DB 305. The user who wishes to retrieve a message sends from the terminal 102 an e-mail of a predetermined format indicating a message retrieval request to the server 100 (Step S1001).

This e-mail includes the e-mail address (for instance, sgibbs@fuji.com) of the server 100 in the receiver's address field and the e-mail address of the terminal 102 in the sender's address field. The title field is left blank (that is, without entry) when retrieving the messages of all the members who have specified one as the permitted user, and the full name of the member is entered in the title field to narrow down retrieving messages of a specific member. The main body may be blank.

The control unit 300 of the server 100 receives the e-mail via the receiving unit 301 (Step S1002) and identifies it as a message-retrieving request. The control unit 300 then instructs the message-retrieving unit 307 to retrieve from the user DB 304 the users who have specified the requesting party (more accurately, the sender's address in the e-mail) as a permitted user and the user (if any) specified by the requesting party (Step S1003).

For instance, if the user DB 304 includes the contents shown in FIG. 4, let us suppose that the ‘Fuji General Affairs Department’, which is the seeker, is sending the following e-mail from the terminal 102 to the server 100.
Receiver's address: sgibbs@fuji.com
Sender's address: soumu@xx.fuji.com
Title: (Blank)
   In response, all the members who have specified ‘Fuji General Affairs Department’ as the permitted user are retrieved in Step S1003, and they are ‘Yamada Taro’, ‘Suzuki Taro’, and ‘Sato Taro’.

On the contrary, if a full name is entered in the title as given below,
Receiver's address: sgibbs@fuji.com
Sender's address: soumu@xx.fuji.com
Title: Yamada Taro
   the user ‘Yamada Taro’ only will be retrieved in Step S1003. If only ‘Taro’ is entered in the title, all the three users, namely, ‘Yamada Taro’, ‘Suzuki Taro’, and ‘Sato Taro’, will be retrieved.

In this way, by entering a keyword (full name, in this case) in the title field, the search can be narrowed down to a specific member from among of a plurality of members who have specified one as a permitted user. Even if there are several users having the same full name, only one or at the most a few among them is likely to specify one as a permitted user. Hence, the user can be appropriately narrowed down by the full name.

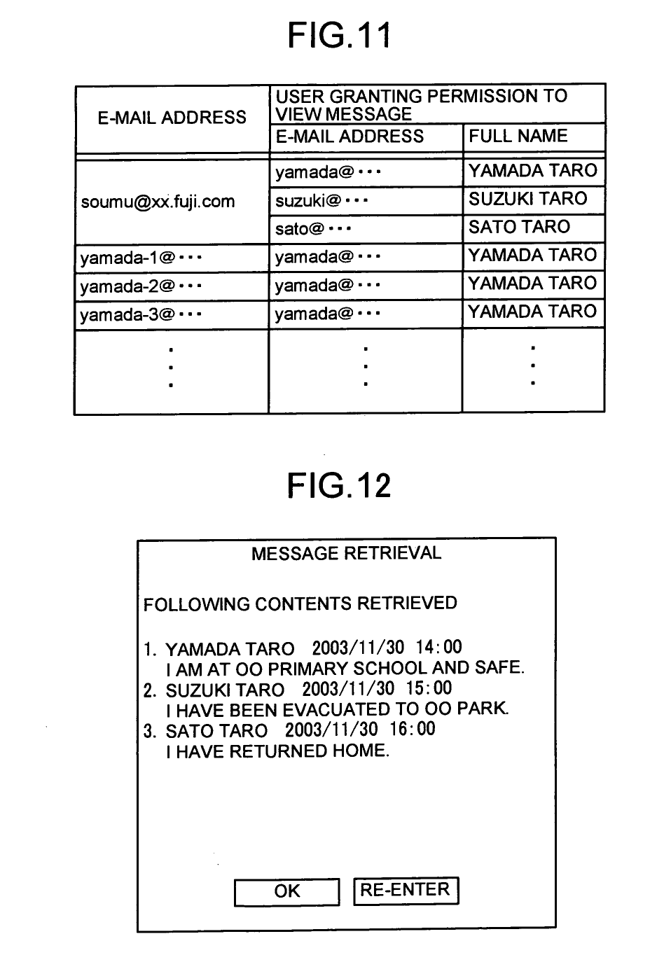

The explanation so far was based on the structure of the user DB 304 shown in FIG. 4. FIG. 11 is another example of contents of the user DB 304. This structure of the database allows looking up the users (their e-mail addresses and full names) who have specified one as a permitted user by using the users' e-mail address as a keyword. In other words, in the structure user DB 304 shown in FIG. 4, all the three users, namely, ‘Yamada Taro’, ‘Suzuki Taro’, and ‘Sato Taro’ have specified ‘Fuji General Affairs Department’ as a permitted user. A reverse correlation is established in the structure of the user DB 304. That is, the permitted user ‘Fuji General Affairs Department’ is correlated with the three users who have granted ‘Fuji General Affairs Department’ permission to view their messages. Thus, by organizing the database, the retrieval process in Step S1003 in FIG. 10 can be speeded up.

Returning to FIG. 10, even if one member satisfying the condition in Step S1003 is retrieved (‘Yes’ in Step S1004), the message-retrieving unit 307 retrieves from the message DB 305, the message registered by the member (Step S1005). In other words, the message-retrieving unit 307 retrieves the message correlated to the e-mail address of the member. Even if only one message is retrieved (‘Yes’ in Step S1006), the message-retrieving unit 307 creates a message list that includes the contents of the message (text, date and time of registration, etc.) and the information pertaining to the member (full name, etc.) (Step S1007), and passes on the message list to the control unit 300.

On the other hand, if there is no relevant member (‘No’ in Step S1004) or when the relevant member has not registered any message (‘No’ in Step S1006), the message-retrieving unit 307 creates a retrieval error notice (Step S1008) indicating that there is no message and passes on a retrieval error notice to the control unit 300.

The control unit 300 sends to the terminal 102 the message list or the retrieval error notice (hereinafter, together “search result”) via the transmitting unit 302 (Steps S1009 and S1010). The terminal 102 displays on the screen the search result, as shown in FIG. 12 (Step S1011). The example shown in FIG. 12 is a message list. When the control unit 300 sends the retrieval error notice, the terminal 102 displays an error message, such as, ‘Message not found. Please try again.’ is displayed.

Thus, according to the present embodiment, since the message registered by each user is open only to the pre-specified user, the member's privacy is protected. The seeker also can check merely by sending an e-mail with a blank title the safety of all the users who specify the seeker as the permitted user and by entering the full name of a specific user, the safety of the user. Thus, quick and efficient verification of the safety of a plurality of users can be done. Furthermore, the reduced frequency with which the user accesses the system results into decrease in the load and traffic on the system.

The present embodiment so far explains only the registration of the user and the message. However, it is also possible to delete the user and the message. For instance, to delete a pre-registered message, an email that includes the e-mail address of the server 100 (for instance, sgibbs@fuji.com) in the receiver's address field, the e-mail address of the terminal 101 in the sender's address field, and the message ID along with the specific text string DEL (if the message ID is ‘123456789’, the title would be ‘123456789DEL’) in the title field is sent to the server 100. The server 100 assesses from the format of the title that the request is for deleting the message and deletes, with the aid of a not shown message-deleting unit, the message having the corresponding message ID in the message DB 305 and sends a deletion completion notice to the terminal 101.

It has been explained that each user specifies one or more permitted users. However, provision may be made for the user to specify permitted user for every message. Moreover, there is no restriction on the number of the messages a single user can register and hence, one user can register several messages. For instance, only family members may be selectively specified as permitted users for a message 1 meant for the family, and only colleagues may be selectively specified for permitted users for a message 2 meant for official purposes, thereby allowing changing of the permitted user for every message.

The data retrieval method can be realized by executing a prepared computer program on a computer such as a personal computer, a workstation, and the like. The computer program is stored on a computer-readable recording medium such as the hard disk 205, the flexible disk 207, the CD-ROM, the MO, the DVD, and the like. The computer executes the program by loading it from the recording medium. This program may be a transmission medium that can be distributed via a network such as the Internet.

According to present invention, the message posted by a user can be retrieved quickly and efficiently and by (only) permitted users specified by the user who posts the message.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A data retrieval method that retrieves messages registered in a database, comprising:
receiving a retrieval request from a first user;
identifying the first user based on the retrieval request;
retrieving a second user from the database who has specified the first user as a permitted user;
retrieving a message from the database that is registered by the second user; and
transmitting the message to the first user.

2. The data retrieval method according to claim 1, wherein the retrieving a second user includes retrieving a plurality of second users, and retrieving, from among the second users, a second user who has been specified by the first user in the retrieval request.

3. The data retrieval method according to claim 2, wherein the retrieving a second user includes retrieving, from among the second users, the second user based on name specified by the first user in the retrieval request.

4. The data retrieval method according to claim 1, wherein retrieval request is in the form of an e-mail message, and the identifying includes identifying the first user based sender's address in the e-mail message.

5. A computer program that includes instructions which when executed on a computer cause the computer to execute retrieval of messages registered in a database, the computer program making the computer execute:
receiving a retrieval request from a first user;
identifying the first user based on the retrieval request;
retrieving a second user from the database who has specified the first user as a permitted user;
retrieving a message from the database that is registered by the second user; and
transmitting the message to the first user.

6. The computer program according to claim 5, wherein the retrieving a second user includes retrieving a plurality of second users, and retrieving, from among the second users, a second user who has been specified by the first user in the retrieval request.

7. The computer program according to claim 6, wherein the retrieving a second user includes retrieving, from among the second users, the second user based on name specified by the first user in the retrieval request.

8. The computer program according to claim 5, wherein retrieval request is in the form of an e-mail message, and the identifying includes identifying the first user based sender's address in the e-mail message.

9. A data retrieval device that retrieves messages registered in a database, comprising:
a receiving unit that receives a retrieval request from a first user;
an identifying unit that identifies the first user based on the retrieval request;
a user retrieving unit that retrieves a second user from the database who has specified the first user as a permitted user;
a message retrieving unit that retrieves a message from the database that is registered by the second user; and
a transmitting unit that transmits the message to the first user.

10. The data retrieval device according to claim 9, wherein the user retrieving unit retrieves a plurality of second users, and retrieves, from among the second users, a second user who has been specified by the first user in the retrieval request.

11. The data retrieval device according to claim 10, wherein the user retrieving unit retrieves, from among the second users, the second user based on name specified by the first user in the retrieval request.

12. The data retrieval device according to claim 9, wherein retrieval request is in the form of an e-mail message, and the identifying unit identifies the first user based sender's address in the e-mail message.

13. A computer-readable recording medium that stores a computer program that includes instructions which when executed on a computer cause the computer to execute retrieval of messages registered in a database, the computer program making the computer execute:
receiving a retrieval request from a first user;
identifying the first user based on the retrieval request;
retrieving a second user from the database who has specified the first user as a permitted user;
retrieving a message from the database that is registered by the second user; and
transmitting the message to the first user.

14. The computer-readable recording medium according to claim 13, wherein the retrieving a second user includes retrieving a plurality of second users, and retrieving, from among the second users, a second user who has been specified by the first user in the retrieval request.

15. The computer-readable recording medium according to claim 14, wherein the retrieving a second user includes retrieving, from among the second users, the second user based on name specified by the first user in the retrieval request.

16. The computer-readable recording medium according to claim 13, wherein retrieval request is in the form of an e-mail message, and the identifying includes identifying the first user based sender's address in the e-mail message.
